(19) United States
(12) Patent Application Publication
(10) Pub. No.: US 2018/0298661 A1
(43) Pub. Date: Oct. 18, 2018

(54) HINGE FOR FURNITURE LEAVES THAT SWING ABOUT AT LEAST ONE HORIZONTAL AXIS

(71) Applicant: ARTURO SALICE S.P.A., Novedrate (IT)

(72) Inventor: Luciano SALICE, Carimate (IT)

(73) Assignee: ARTURO SALICE S.P.A., Novedrate (IT)

(21) Appl. No.: 15/569,461

(22) PCT Filed: Apr. 27, 2016
(86) PCT No.: PCT/EP2016/059385

§ 371 Date: Oct. 26, 2017

(30) Foreign Application Priority Data
Apr. 30, 2015 (IT) MI2015A000618

(51) Int. Cl. E05F 1/10; E05D 15/40; E05F 3/20

(52) U.S. Cl. CPC E05F 1/105; E05Y 2900/20; E05F 3/20; E05D 15/401

(57) ABSTRACT

A hinge for furniture leaves that swing about at least one horizontal axis, which comprises a supporting body which is adapted to be applied inside a piece of furniture, at least one oscillating lever adapted to be connected to the supporting body at one end and, at the opposite end, to an anchoring element which is fixed to a leaf, the at least one lever being applied so as to oscillate to an intermediate body that is separate from the supporting body.

The present invention relates to a hinge for furniture leaves that swing about at least one horizontal axis.

More specifically, the invention relates to a hinge for furniture leaves that can be opened upwardly or downwardly, according to at least one horizontal axis.

As is known, in the furniture sector pieces of furniture are in use which have leaves that can be opened by lifting upwardly, by way of an oscillating motion about at least one horizontal axis.

Leaves of this type are connected to a fixed part of the piece of furniture by way of hinges that define lifting systems that comprise a supporting body, connected to the fixed part of the piece of furniture, and at least one lifting lever which is supported so as to oscillate by the supporting body and is adapted to be anchored to the leaf of the piece of furniture.

Spring-loaded actuation devices are also provided which make it possible to support the leaf during its oscillating motion for opening or closing, and adjustment systems. All this makes the hinge complex and cumbersome. Therefore, in general, the supporting body, and also the lifting lever, must be connected to the sides of the piece of furniture, and the leaves are connected to the lifting lever only in the final step of assembly.

In particular, the lifting lever, at the end that is to be anchored to the leaf, has a fixing element which can be connected by way of fastening means with anchoring elements which are fixed before the leaf.

Usually, the assembly of hinges of this type (where the term “hinge” means the entirety of elements that make up the system for lifting and/or for supporting the leaf of the piece of furniture) comes about by way of the following steps:
first of all, the supporting body and the corresponding lifting lever of a hinge is fixed to the fixed part of the piece of furniture, often using templates to fix it in the correct position;
then the anchoring elements are fixed to the leaf; and
last of all, the anchoring elements applied to the leaf are engaged with the respective fixing elements provided at the ends of the lifting levers which were previously fixed to the supporting bodies.

However, the above fixing operations involve a certain level of difficulty, especially for massive leaves, in that the presence is often required of two persons for assembly, to support the leaf and to perform the movement of that leaf which is necessary to correctly engage the anchoring element of the leaf with the respective fixing elements on the levers of the lifting systems which are already fixed to the fixed part of the piece of furniture.

The aim of the present invention is to provide a hinge for furniture leaves that swing about at least one horizontal axis, which simplifies the assembly, which can be carried out by a single person, even if the leaves are of a considerable size.

Within this aim, an object of the present invention is to provide a hinge for furniture leaves that swing about at least one horizontal axis, which is configured for leaves that can be opened upwardly or downwardly, and can be mounted in a simple and rapid manner.

Another object of the present invention is to provide a hinge for furniture leaves that swing about at least one horizontal axis which is highly reliable, easily and practically implemented and low cost.

This aim and these and other objects which will become better apparent hereinafter are achieved by a hinge for furniture leaves that swing about at least one horizontal axis, which comprises a supporting body which is adapted to be applied inside a piece of furniture, at least one oscillating lever adapted to be connected to said supporting body at one end and, at the opposite end, to an anchoring element which is fixed to a leaf, characterized in that said at least one lever is applied so as to oscillate to an intermediate body that is separate from said supporting body.

Further characteristics and advantages of the invention will become better apparent from the description of a preferred, but not exclusive, embodiment of the hinge according to the present invention, which is illustrated by way of non-limiting example in the accompanying drawings wherein:

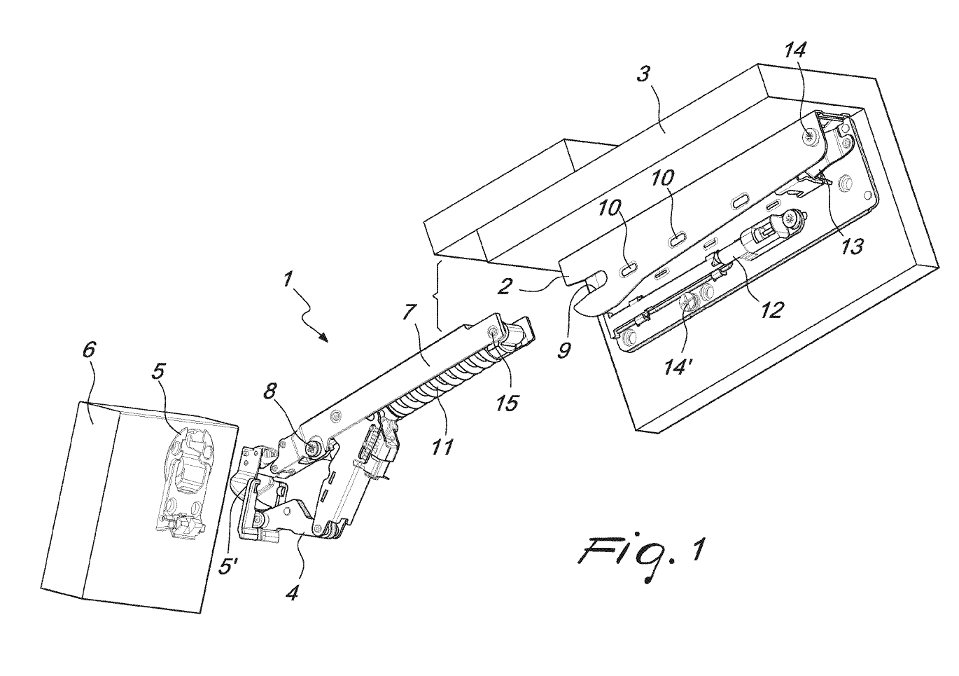

FIG. 1 is an exploded perspective view of the hinge according to the present invention;

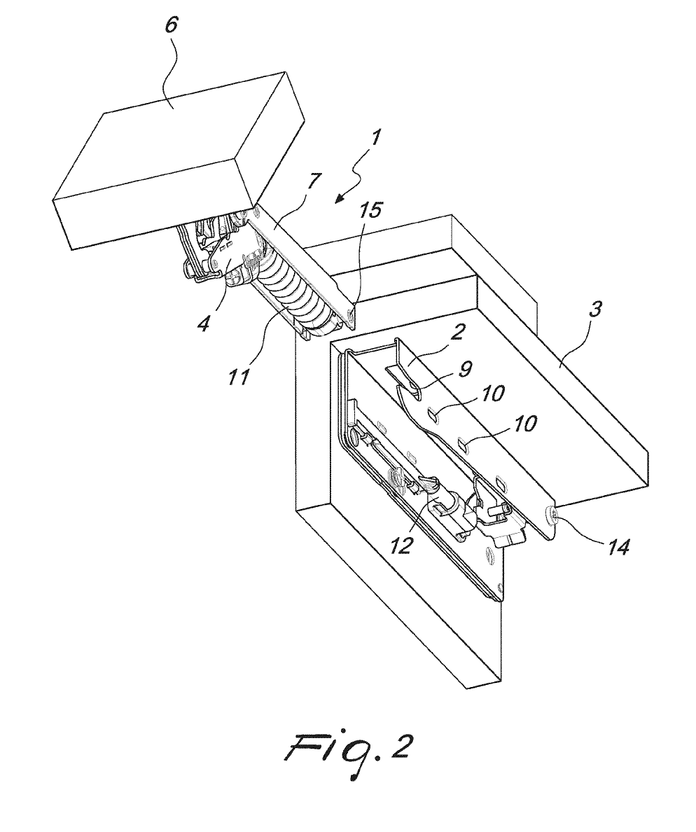

FIG. 2 is a perspective view, partially assembled, of the hinge according to the present invention;

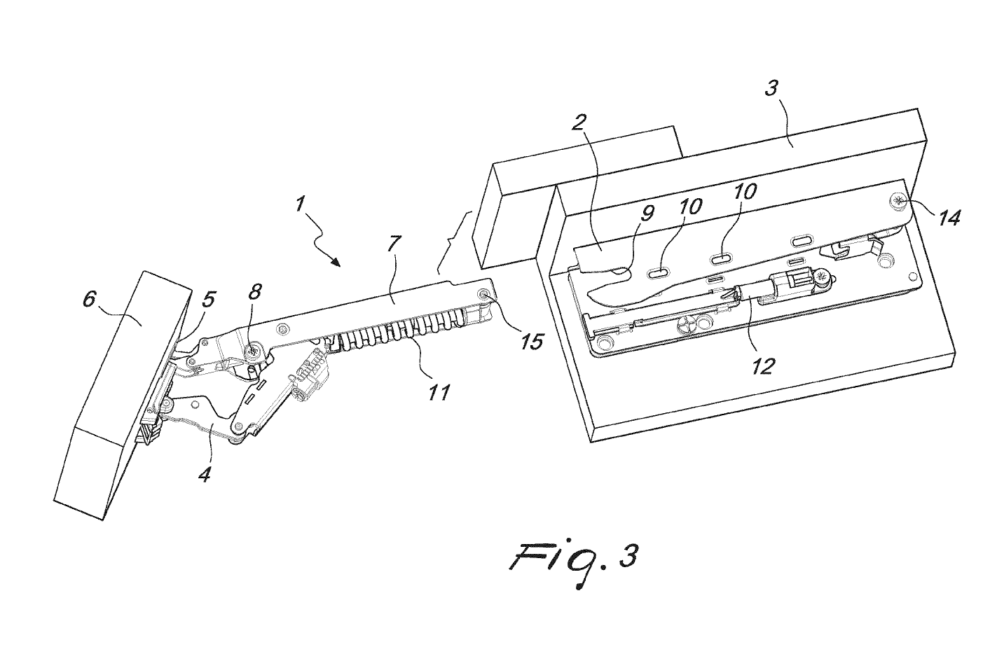

FIG. 3 is a further perspective view of the hinge in FIG. 1 and FIG. 2;

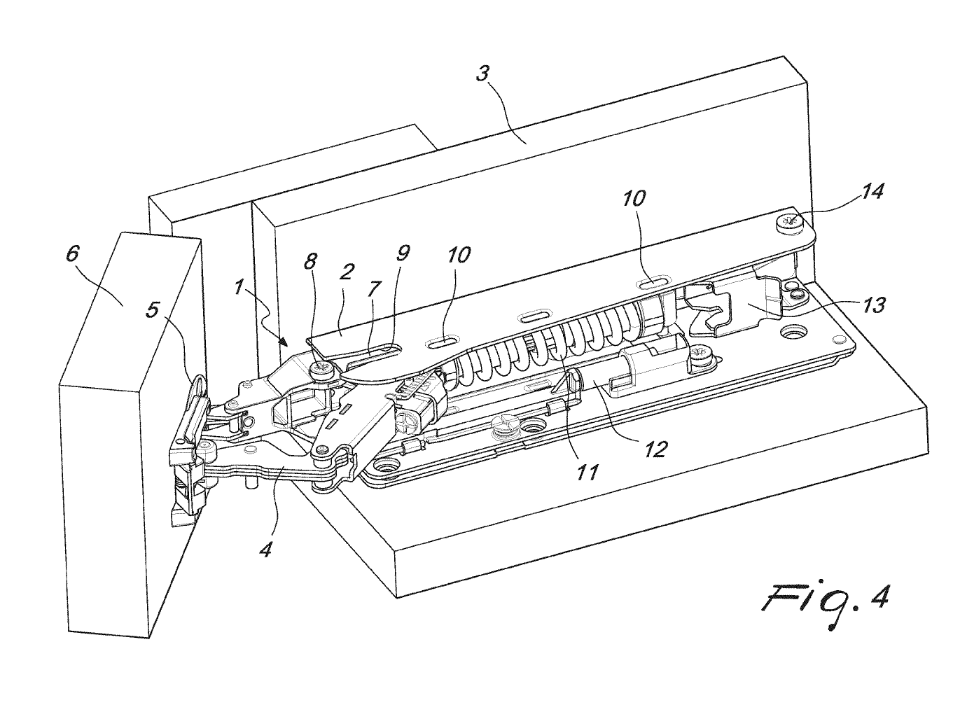

FIG. 4 is a perspective view of the hinge according to the invention in a partially assembled condition;

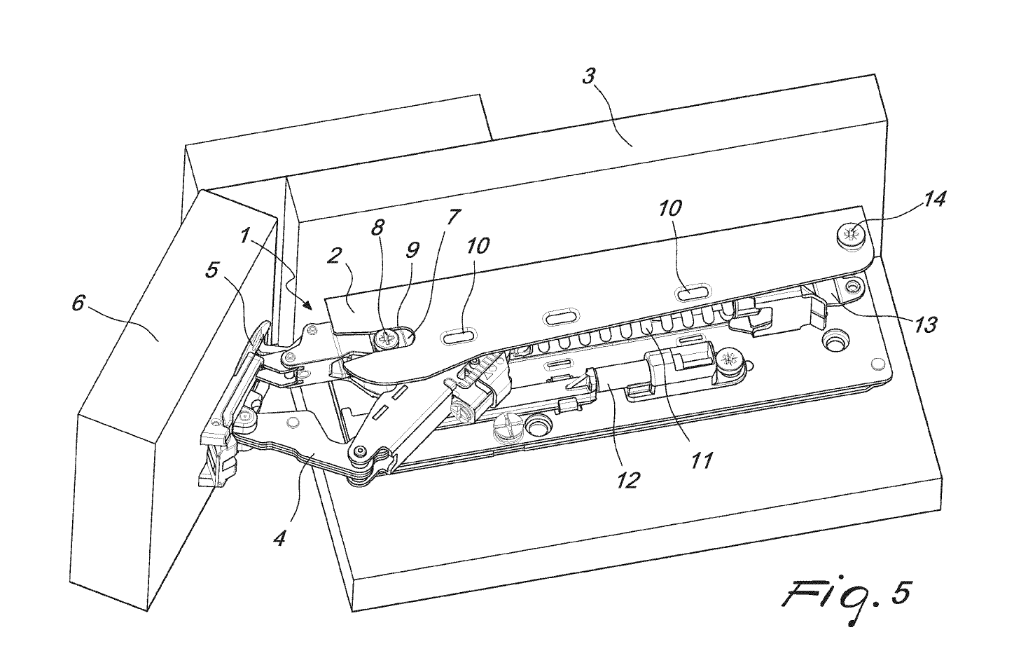

FIG. 5 is a further perspective view of the hinge according to the invention in the assembled condition;

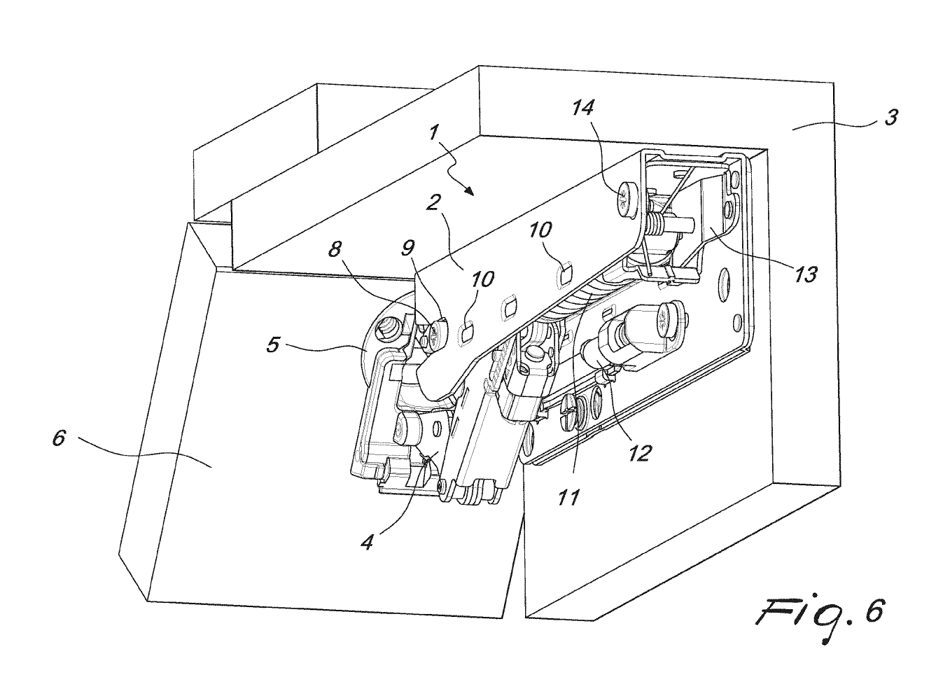

FIG. 6 is another perspective view of the hinge according to the invention in the assembled condition.

With reference to the figures, the hinge according to the invention, generally designated by the reference numeral 1, comprises a supporting body 2 which is adapted to be fixed to an inner part of a fixed portion 3 of a piece of furniture, and at least one oscillating lever 4 for lifting which is adapted to be connected to an anchoring element 5 applied to a leaf 6 of the piece of furniture by way of a coupling element 5′ connected to the lifting lever 4.

The hinge according to the invention has an intermediate body 7, separate from the supporting body 2, which supports the lifting lever 4 so as to oscillate.

Substantially, therefore, the hinge according to the invention introduces an intermediate body 7 to which the lifting lever 4 is applied so as to oscillate, and the intermediate body 7 is provided with a cam screw 8 for vertically adjusting the position of the leaf. The cam screw engages, when the intermediate body 7 is assembled in the supporting body 2, with a seat 9 defined at the front end of the supporting body 2.

The supporting body 2 is provided internally with a plurality of humps or drawn portions 10 which constitute guiding elements for inserting the intermediate body 7 inside the supporting body 2.

The supporting body 2 is preferably shaped substantially like an inverted U; however, the possibility is not ruled out of its having a transverse cross-section of a different shape, for example tubular.

The intermediate body 7 accommodates elastic means 11 which make it possible to support the leaf 6 during its oscillating motion; in particular, if the hinge is configured to support a leaf that can be opened upwardly, the elastic means are shaped and arranged to provide the necessary lifting force to support the leaf during the opening movement, but if the hinge is configured to support a leaf that can be opened downwardly, the elastic means are shaped and arranged to provide a force for closing the leaf and/or a supporting force for controlling the movement to open the leaf.

The supporting body 2 accommodates a braking device 12 which interacts with the lifting lever 4 in order to brake the oscillating motion of the leaf 6 about its horizontal axis.

Finally, the supporting body 2 accommodates, at the rear end opposite the end for insertion of the intermediate body 7, a clip 13, which couples with the end 15 of the intermediate body 7 when the latter is inserted in the supporting body 2.

The clip 13 is connected to the supporting body 2 so that it can move according to the longitudinal direction of extension of the body 2, and the position of the clip 13 can be defined and adjusted by way of a cam screw 14, thus making it possible to adjust the leaf 6 in a front direction.

Conveniently, the supporting body 2 is accommodated in the corner defined by the walls of the piece of furniture, with the top or with a horizontal intermediate plane or with the bottom of the piece of furniture, and can be fixed to the side of the piece of furniture or to the “top” of the piece of furniture.

Furthermore, preferably the supporting body 2 also has lateral adjustment means so as to allow an adjustment of the position of the leaf in a lateral direction; for example the supporting body 2 can have a side wall defined by two splayable plates, the splaying of which is defined in a controlled manner by way of an adjustment screw 14′.

Method of mounting the hinge according to the invention is as follows.

Firstly, the operator connects the supporting body 2 inside the piece of furniture 3, then connects the intermediate body 7 and the corresponding lever 4 to the leaf 6, by connecting the coupling element 5′ which is integral with the lever 4 with the anchoring element 5 which is preferably countersunk into the thickness of the leaf 6.

The coupling between the coupling element 5′ of the lever 4 and the anchoring element 5 preferably occurs with snap-fitting engagement.

At this point, the operator can, alone, connect the leaf 6 to the piece of furniture 3 by inserting the intermediate body 7 of each hinge in the corresponding supporting body 2, simply by making the intermediate body 7 slide into the supporting body 2, in a guided manner thanks to the elements 10, until the former engages within the latter.

This operation can be carried out by the operator without any need for help, thus simplifying the steps of assembling the piece of furniture.

In practice it has been found that the hinge according to the present invention fully achieves the set aim and objects, in that it makes it possible to simplify the operations of assembling a piece of furniture, and in particular of a piece of furniture with leaves that swing about at least one horizontal axis.

The invention can be applied both to leaves that open upwardly and to leaves that open downwardly.

The invention, thus conceived, is susceptible of numerous modifications and variations, all of which are within the scope of the appended claims.

Moreover, all the details may be substituted by other, technically equivalent elements.

In practice the materials employed, and the contingent dimensions and shapes, may be any according to requirements and to the state of the art. The disclosures in Italian Patent Application No. MI2015A000618 (102015902347516) from which this application claims priority are incorporated herein by reference.

1-12. (Canceled)

13. A hinge for furniture leaves that swing about at least one horizontal axis, which comprises a supporting body which is adapted to be applied inside a piece of furniture, at least one oscillating lever adapted to be connected to said supporting body at one end and, at the opposite end, to an anchoring element which is fixed to a leaf, wherein said at least one lever is applied so as to oscillate to an intermediate body that is separate from said supporting body.

14. The hinge according to claim 13, wherein said intermediate body is provided with adjustment means for the vertical adjustment of the leaf, said adjustment means being adapted to engage a seat defined in said supporting body when said intermediate body is accommodated in said supporting body.

15. The hinge according to claim 13, wherein said supporting body comprises a plurality of guiding means which are adapted to allow the guided sliding of said intermediate body within said supporting body.

16. The hinge according to claim 13, wherein said supporting body is provided with a damping device in order to brake said leaf.

17. The hinge according to claim 13, wherein said supporting body is provided, at an end that lies opposite an end for insertion of said intermediate body, with a retention clip for said intermediate body within said supporting body.

18. The hinge according to claim 17, wherein said retention clip is supported so that it can move by said supporting body and is adjustable in a front direction.

19. The hinge according to claim 13, wherein said supporting body is provided with means for adjustment in a lateral direction.

20. The hinge according to claim 13, wherein said anchoring element is embedded within the thickness of said leaf.

21. The hinge according to claim 13, wherein said intermediate body accommodates spring-loaded actuation means for supporting the leaf during its oscillation.

22. The hinge according to claim 13, wherein said supporting body is shaped like an inverted U and is adapted to accommodate said intermediate body.

23. The hinge according to claim 13, wherein said supporting body has a tubular cross-section.

24. A method for mounting a hinge according to claim 13, comprising the steps of:
applying said supporting body to a piece of furniture;
fixing the intermediate body with the corresponding lever by way of anchoring on a leaf;
applying the leaf, with the corresponding intermediate body fixed thereto, to said piece of furniture, coupling said intermediate body within said supporting body.
